(19) United States
(12) Patent Application Publication
(10) Pub. No.: US 2025/0269814 A1
(43) Pub. Date: Aug. 28, 2025

(54) FRONT STRUCTURE OF VEHICLE

(71) Applicant: TOYODA GOSEI CO., LTD., Kiyosu-shi (JP)

(72) Inventors: Takaki ITATSU, Aichi (JP); Koichi SUZUKI, Aichi (JP); Tomohiro KAJITANI, Aichi (JP); Masashi OTOYO, Aichi (JP); Hiroshi TAKAKURA, Aichi (JP)

(21) Appl. No.: 19/058,164

(22) Filed: Feb. 20, 2025

(30) Foreign Application Priority Data
Feb. 22, 2024 (JP) 2024-025341

(51) Int. Cl. B60R 19/34

(52) U.S. Cl. CPC B60R 19/34

(57) ABSTRACT

A front structure of a vehicle has a pair of vehicle body frames, a pair of crash boxes, a support member, and a bumper reinforcement. The vehicle body frames are disposed at an interval in a width direction of the vehicle. The crash boxes are located in front of the vehicle body frames to be attached to the vehicle body frames. The support member includes a support body located between the crash boxes, and a pair of extension portions extending outward in the width direction from the support body on both sides. The bumper reinforcement extends in the width direction to be attached to front ends of the crash boxes. The extension portion includes a guide portion which guides the crash box to an attachment position by engaging with the crash box. The guide portion has a surface inclined with respect to a front-rear direction of the vehicle.

### CROSS-REFERENCE TO RELATED APPLICATIONS

This application is based on and claims priority under 35 USC 119 from Japanese Patent Application No. 2024-025341 filed on Feb. 22, 2024, the entire content of which is incorporated herein by reference.

### TECHNICAL FIELD

The present disclosure relates to a front structure of a vehicle.

### BACKGROUND ART

JP2019-059415A describes a front structure of a vehicle. The front structure of a vehicle described in JP2019-059415A includes a pair of front side members located on both sides in a vehicle width direction, and a pair of crash boxes coupled to respective front ends of the pair of front side members. The front structure of a vehicle further includes a bumper reinforcement coupled to front ends of the pair of crash boxes. The crash boxes each include a tubular main body portion, a first coupling piece that protrudes forward from an upper edge of a front end portion of the main body portion, and a second coupling piece that protrudes downward from a lower edge of the front end portion of the main body portion. A second flange portion is provided at a rear end portion of the main body portion. A second upper hole portion and a second lower hole portion are respectively formed on the first coupling piece and the second coupling piece. First upper holes and first lower holes, which respectively communicate with the second upper holes and the second lower holes, are formed on the bumper reinforcement. Nuts are respectively screwed to bolts inserted through the first upper holes and the second upper holes and bolts inserted through the first lower holes and the second lower holes, whereby the bumper reinforcement is fastened to the pair of crash boxes. The second flange portion is fastened by the bolts to a first flange portion provided at a front end portion of the front side member.

In the front structure of the vehicle in the related art including the structure described in JP2019-059415A, variations in processing accuracy and assembly accuracy of the front side members and variations in processing accuracy and assembly accuracy of the crash boxes occur. Therefore, the first upper holes and the first lower holes of the bumper reinforcement may be displaced with respect to the second upper holes and the second lower holes of the crash boxes, which may make assembly difficult.

Therefore, the bumper reinforcement is assembled to the crash boxes by setting the first upper holes and the first lower holes larger than the second upper holes and the second lower holes in consideration of the above-described variations. However, even in this case, variations in positions of the front ends of the crash boxes with respect to the bumper reinforcement are still large.

Such a circumstance is more remarkable in a vehicle such as a battery electric vehicle (BEV) in which lengths in a front-rear direction of the crash boxes are large.

### SUMMARY OF INVENTION

An aspect of the present disclosure will be described.

(1) The aspect of the present disclosure provides a front structure of a vehicle, including:
a pair of vehicle body frames disposed at an interval in a vehicle width direction;
a pair of crash boxes located in front of the vehicle body frames in a front-rear direction of the vehicle, and attached to the vehicle body frames respectively;
a support member including a support body located between the pair of crash boxes, and a pair of extension portions that extend outward in the vehicle width direction from the support body and are located on both sides of the support body in the vehicle width direction; and
a bumper reinforcement that extends in the vehicle width direction, and is attached to front ends of the pair of crash boxes,
in which the extension portion includes a guide portion configured to guide the crash box to an attachment position by engaging with a front end of the crash box, the guide portion having an inclined surface that is inclined with respect to the front-rear direction.

According to the above-described configuration, the guide portion is engaged with the front end of the crash box, so that a position of the crash box is guided to an attachment position along the inclined surface of the guide portion. Accordingly, a variation in a position of the front end of the crash box, that is, a position of a portion of the crash box to which the bumper reinforcement is attached, is prevented. Therefore, the crash boxes are easily assembled to predetermined positions of the bumper reinforcement.

(2) In the front structure of the aspect, the crash box includes a tubular portion extending in the front-rear direction, and a coupling portion coupled to a front end of the tubular portion and protruding to an outer peripheral side of the tubular portion,
a front end surface of the coupling portion has two engaged portions having a hole shape or an aperture shape and provided at an interval in the vehicle width direction, and
two of the guide portions are inserted into the two engaged portions respectively.

According to the above-described configuration, the two guide portions are inserted into the two engaged portions having the hole shape or the aperture shape, so that the crash box is guided to the attachment position along the inclined surface in the vehicle width direction. Further, the two guide portions are engaged with the two engaged portions, so that a relative movement of the crash box with respect to the support member is restricted. Therefore, the crash box can be fixed at the attachment position.

(3) In the front structure of the aspect, the crash box includes a tubular portion extending in the front-rear direction, and a coupling portion coupled to a front end of the tubular portion,
the coupling portion has a cutout portion not protruding outward in a radial direction of the tubular portion, and
the guide portion has a pair of the inclined surfaces configured to sandwich the cutout portion from an inner peripheral side and an outer peripheral side of the tubular portion in the vehicle width direction, and a facing surface facing a front end of the cutout portion.

According to the above-described configuration, the guide portion is engaged with the cutout portion of the coupling portion, so that the crash box is guided to an attachment position along the inclined surface in the vehicle width direction. Further, the cutout portion is surrounded by the pair of inclined surfaces and the facing surface, so that a relative movement of the crash box with respect to the support member is restricted. Therefore, the crash box can be fixed at the attachment position.

(4) In the front structure of the aspect, the support member including the support body and the pair of extension portions is integrally molded.

According to the above-described configuration, since the members constituting the support member are integrally molded, the accuracy of a shape of the support member is improved. Therefore, the guide to the attachment position implemented by the guide portions is accurately performed.

(5) In the front structure of the aspect, the support member is made of a fiber reinforced resin.

According to the above-described configuration, by using the support member made of the fiber reinforced resin, it is possible to reduce a weight of the support member while maintaining a strength of the support member.

(6) In the front structure of the aspect, the crash box includes a tubular portion extending in the front-rear direction, and a coupling portion coupled to a front end of the tubular portion and protruding to an outer peripheral side of the tubular portion, and
a front end surface of the coupling portion has an accommodating recessed portion configured to accommodate the extension portion.

According to the above-described configuration, in the case where the extension portion made of the resin is located between the coupling portion, which is the front end of the crash box, and the bumper reinforcement, the extension portion is accommodated in the accommodating recessed portion. Accordingly, a compressive stress acting on the extension portion sandwiched between the crash box and the bumper reinforcement can be reduced.

Therefore, creep deformation of the extension portion is prevented. Therefore, the durability of the support member can be improved.

(7) In the front structure of the aspect, a rear surface of the bumper reinforcement has an accommodating recessed portion configured to accommodate the extension portion.

According to the above-described configuration, in the case where the extension portion made of the resin is located between the coupling portion, which is the front end of the crash box, and the bumper reinforcement, the extension portions are accommodated in the accommodating recessed portion. Accordingly, a compressive stress acting on the extension portion sandwiched between the crash box and the bumper reinforcement can be reduced. Therefore, creep deformation of the extension portion is prevented. Therefore, the durability of the support member can be improved.

According to the aspect of the present disclosure, the crash boxes are easily assembled to predetermined positions of the bumper reinforcement.

### BRIEF DESCRIPTION OF DRAWINGS

Exemplary embodiment(s) of the present invention will be described in detail based on the following figures, wherein:

FIG. 1 is an exploded perspective view illustrating a front structure of a vehicle according to a first embodiment;

FIG. 2 is a cross-sectional view taken along a line 2-2 in FIG. 1;

FIG. 3 is a cross-sectional view illustrating a state in which a crash box is engaged with an inclined surface of a second guide portion;

FIG. 4 is an exploded perspective view illustrating a front structure of a vehicle according to a second embodiment;

FIG. 5 is a cross-sectional view taken along a line 5-5 in FIG. 4;

FIG. 6 is a cross-sectional view illustrating a state in which a crash box is engaged with inclined surfaces of a guide portion;

FIG. 7 is a perspective view illustrating a modification of a support member; and

FIG. 8 is a cross-sectional view taken along a line 8-8 in FIG. 7.

### DESCRIPTION OF EMBODIMENTS

### First Embodiment

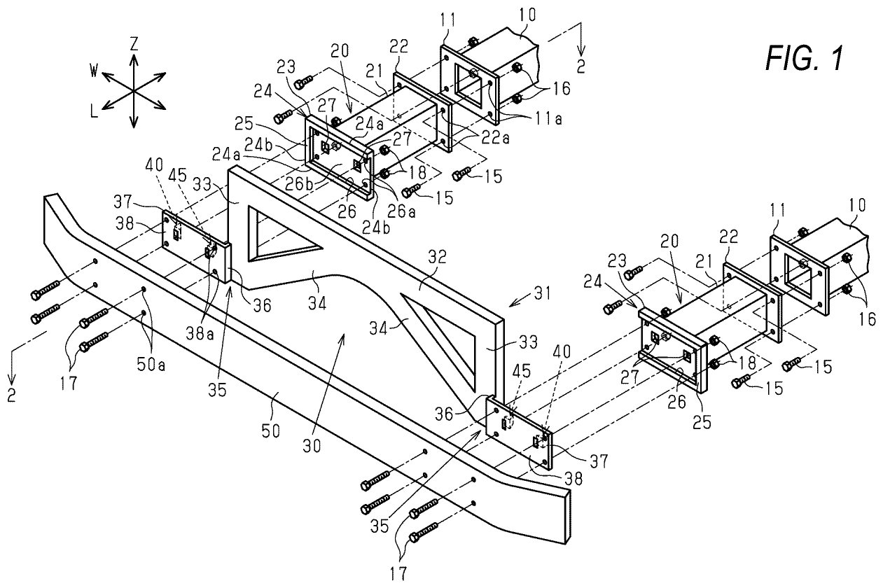

Hereinafter, the first embodiment of a front structure of a vehicle will be described with reference to FIGS. 1 to 3.

As illustrated in FIG. 1, the front structure of a vehicle includes a pair of front side members 10, a pair of crash boxes 20, a support member 30, and a bumper reinforcement 50.

In the following description, a front-rear direction of the vehicle is referred to as a front-rear direction L, a vehicle width direction is referred to as a vehicle width direction W, and an upper-lower direction of the vehicle when the vehicle is located on a horizontal plane is referred to as an upper-lower direction Z.

Further, a front side and a rear side in the front-rear direction L are simply referred to as a “front side” and a “rear side” respectively.

The vehicle according to the present embodiment has a symmetrical structure in the vehicle width direction W. Therefore, hereinafter, the left half of the vehicle at the time when viewed from the front to the rear will be described, and a description for the right half may be omitted.

### <Front Side Member 10>

As illustrated in FIG. 1, the pair of front side members 10 are tubular and extend in the front-rear direction L, and are disposed at an interval in the vehicle width direction W.

A vehicle body-side flange portion 11 having a rectangular annular shape in a front view, which protrudes outward in a radial direction of the front side member 10, is provided at a front end of the front side member 10. A through hole 11a, which penetrates the vehicle body-side flange portion 11 in the front-rear direction L, is formed at each of four corner portions of the vehicle body-side flange portion 11.

### <Crash Box 20>

As illustrated in FIG. 1, the pair of crash boxes 20 are located in front of the front side members 10 and are attached to the front side members 10 respectively.

The crash box 20 includes a tubular portion 21 extending in the front-rear direction L, a tubular portion-side flange portion 22 coupled to a rear end of the tubular portion 21, and a coupling portion 23 coupled to a front end of the tubular portion 21.

The tubular portion-side flange portion 22 protrudes outward in a radial direction of the tubular portion 21 from the rear end of the tubular portion 21 and has a rectangular annular shape in a rear view.

On the tubular portion-side flange portion 22, through holes 22a are formed at positions corresponding to the through holes 11a of the vehicle body-side flange portion 11.

The crash box 20 is attached to the front end of the front side member 10 by screwing nuts 16 to respective bolts 15 inserted through the through holes 22a and 11a.

The coupling portion 23 protrudes to an outer peripheral side of the tubular portion 21 and has a rectangular plate shape in a front view. The coupling portion 23 has a pair of long sides 24a and a pair of short sides 24b.

The front end of the tubular portion 21 is welded to a rear end surface of the coupling portion 23.

The coupling portion 23 has a front end surface 24 that is a surface opposite to the rear end surface in the front-rear direction L.

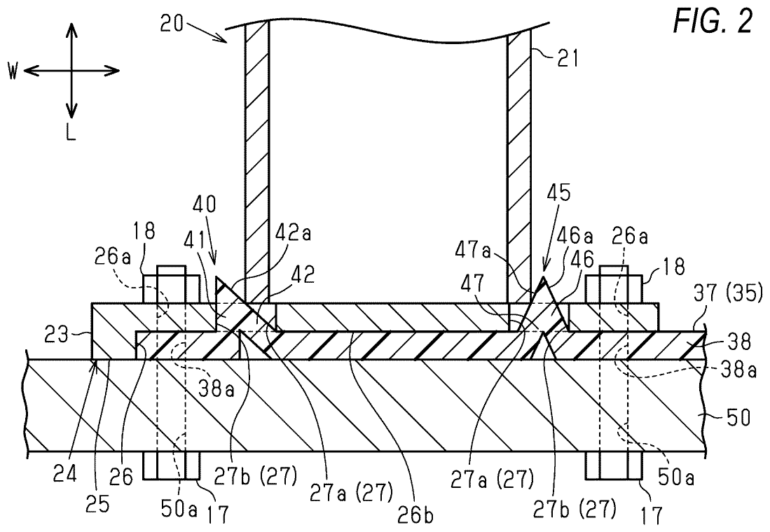

As illustrated in FIGS. 1 and 2, the front end surface 24 includes a flat portion 25 and an accommodating recessed portion 26 that is recessed rearward with respect to the flat portion 25.

As illustrated in FIG. 1, the flat portion 25 is formed along the pair of long sides 24a and the short side 24b on an outer side in the vehicle width direction W.

The accommodating recessed portion 26 is formed by cutting out the front end surface 24, and opens inward in the vehicle width direction W and forward.

A bottom surface 26b of the accommodating recessed portion 26 has a rectangular shape in a front view.

A through hole 26a, which penetrates the accommodating recessed portion 26 in the front-rear direction L, is formed at each of four corner portions of the bottom surface 26b of the accommodating recessed portion 26.

Two holes 27 are formed at an interval in the vehicle width direction W on a bottom surface 26b of the accommodating recessed portion 26.

As illustrated in FIG. 2, the two holes 27 each have a rectangular shape in a front view, extend in the upper-lower direction Z, and have an inner peripheral edge 27a and an outer peripheral edge 27b that are formed at an interval in the vehicle width direction W.

The inner peripheral edge 27a is located more inward of the tubular portion 21 in the radial direction than an outer peripheral surface of the tubular portion 21.

The outer peripheral edge 27b is located more outward of the tubular portion 21 in the radial direction than the outer peripheral surface of the tubular portion 21.

The crash box 20 is made of a metal.

### <Support Member 30>

As illustrated in FIGS. 1 and 2, the support member 30 is attached to the pair of crash boxes 20 to maintain a posture of the pair of crash boxes 20.

The support member 30 is made of a fiber reinforced resin. A reinforcing fiber contained in the fiber reinforced resin is, for example, a glass fiber.

As illustrated in FIG. 1, the support member 30 includes a support body 31 located between the pair of crash boxes 20 and a pair of extension portions 35 that extend outward in the vehicle width direction W from the support body 31 and are located on both sides of the support body 31 in the vehicle width direction W.

In the present embodiment, the support body 31 and the pair of extension portions 35 are integrally molded by injection molding.

### (Support Body 31)

As illustrated in FIG. 1, the support body 31 includes an upper wall portion 32 extending in the vehicle width direction W, a pair of side wall portions 33 extending downward from both ends in the vehicle width direction W of the upper wall portion 32, and a pair of inclined portions 34 extending from lower ends of the pair of side wall portions 33 toward a central portion of the upper wall portion 32.

A headlight and a hood lock for a bonnet hood (both not illustrated) are attached to the upper wall portion 32.

The inclined portion 34 is inclined such that the more inward a portion is located in the vehicle width direction W, the higher the portion is.

### (Extension Portion 35)

As illustrated in FIG. 1, the extension portion 35 includes a first portion 36 extending forward from a lower end of the side wall portion 33 and a second portion 37 extending outward in the vehicle width direction W from a front end of the first portion 36.

The first portion 36 is located more inward than the crash box 20 in the vehicle width direction W. The front end of the first portion 36 is disposed side by side with the coupling portion 23 in the vehicle width direction W.

As illustrated in FIG. 2, the second portion 37 includes a plate-shaped base portion 38 extending outward in the vehicle width direction W from the front end of the first portion 36, and a first guide portion 40 and a second guide portion 45 that protrude rearward from the base portion 38.

The base portion 38 is accommodated in the accommodating recessed portion 26 of the coupling portion 23.

An outer edge of the base portion 38 extends along an inner edge of the accommodating recessed portion 26 of the coupling portion 23 (see FIG. 1).

A front surface of the base portion 38 is located on the same plane as the flat portion 25 of the front end surface 24.

On the base portion 38, a through hole 38a is formed at each of positions corresponding to the through holes 26a.

### (First Guide Portion 40 and Second Guide Portion 45)

As illustrated in FIG. 2, the first guide portion 40 and the second guide portion 45 are provided at positions corresponding to the holes 27.

The first guide portion 40 and the second guide portion 45 are arranged in order from the outer side in the vehicle width direction W.

The first guide portion 40 includes a first wall portion 41 and a second wall portion 42 that face each other in the vehicle width direction W.

The first wall portion 41 protrudes rearward from the base portion 38 along the front-rear direction L. A rear surface of the first wall portion 41 is in contact with an inner peripheral surface of the hole 27.

The second wall portion 42 is located more inward than the first wall portion 41 in the vehicle width direction W and protrudes from the base portion 38 toward a rear end of the first wall portion 41. The second wall portion 42 is inclined such that the more rearward a portion is located, the more outward the portion is located in the vehicle width direction W. A rear surface of the second wall portion 42 is an inclined surface 42a which is inclined with respect to both the front-rear direction L and the vehicle width direction W, and is in contact with the front end of the tubular portion 21.

The second guide portion 45 includes a third wall portion 46 and a fourth wall portion 47 that face each other in the vehicle width direction W.

The third wall portion 46 is inclined such that the more rearward a portion is located, the more outward the portion is located in the vehicle width direction W. A rear surface of the third wall portion 46 is an inclined surface 46a which is inclined with respect to both the front-rear direction L and the vehicle width direction W.

The fourth wall portion 47 is located more outward than the third wall portion 46 in the vehicle width direction W and protrudes from the base portion 38 toward a rear end of the third wall portion 46. The fourth wall portion 47 is inclined such that the more rearward a portion is located, the more inward the portion is located in the vehicle width direction W. A rear surface of the fourth wall portion 47 is an inclined surface 47a which is inclined with respect to both the front-rear direction L and the vehicle width direction W, and is in contact with the front end of the tubular portion 21.

### <Bumper Reinforcement 50>

As illustrated in FIGS. 1 and 2, the bumper reinforcement 50 has a plate shape, extends in the vehicle width direction W, and is located in front of the pair of crash boxes 20.

On the bumper reinforcement 50, a through hole 50a is formed at each of positions corresponding to the through holes 38a of the base portion 38.

The bumper reinforcement 50 is attached to front ends of the pair of crash boxes 20 by screwing nuts 18 to respective bolts 17 inserted through the through holes 50a, 38a, and 26a.

The bumper reinforcement 50 is made of a metal.

In the present embodiment, the pair of front side members 10 correspond to a pair of vehicle body frames according to the present invention. In the present embodiment, the hole 27 corresponds to an engaged portion according to the present invention.

### Functions of First Embodiment

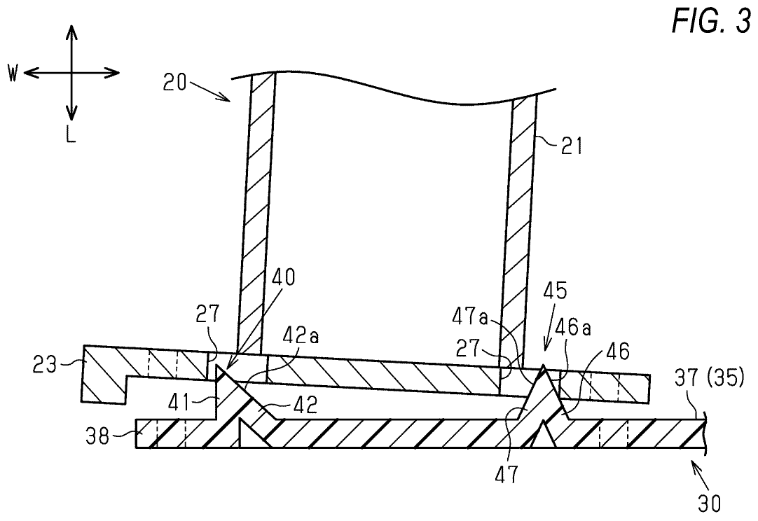

As illustrated in FIG. 3, the second guide portion 45 is engaged with the front end of the crash box 20, so that a position of the crash box 20 is guided to an attachment position along the inclined surface 46a of the second guide portion 45. Accordingly, a variation in a position of the front end of the crash box 20, that is, a position of a portion of the crash box 20 to which the bumper reinforcement 50 is attached, is prevented.

### Effects of First Embodiment

(1-1) The extension portion 35 includes the first guide portion 40 and the second guide portion 45 configured to guide the crash box 20 to the attachment position by engaging with the front end of the crash box 20. The first guide portion 40 and the second guide portion 45 respectively have the inclined surfaces 42a and 46a which are inclined with respect to both the front-rear direction L and the vehicle width direction W.

According to the configuration, the above-described function is implemented, so that the crash boxes 20 are easily assembled to predetermined positions of the bumper reinforcement 50. Accordingly, the bumper reinforcement 50 can be reliably attached to the crash boxes 20.

(1-2) The front end surface 24 of the coupling portion 23 has two holes 27 provided at an interval in the vehicle width direction W. The first guide portion 40 and the second guide portion 45 are respectively inserted into the two holes 27.

According to the configuration, the first guide portion 40 and the second guide portion 45 are respectively inserted into the two holes 27, so that the crash box 20 is guided to the attachment position along the inclined surfaces 42a and 46a in the vehicle width direction W. Further, the first guide portion 40 and the second guide portion 45 are respectively engaged with the two holes 27, so that a relative movement of the crash box 20 with respect to the support member 30 is restricted. Therefore, the crash box 20 can be fixed at the attachment position.

(1-3) The support member 30 is integrally molded.

According to such a configuration, since members constituting the support member 30 are integrally molded, the accuracy of a shape of the support member 30 is improved. Therefore, the guide to the attachment position implemented by the first guide portion 40 and the second guide portion 45 is accurately performed.

(1-4) The support member 30 is made of the fiber reinforced resin.

According to the configuration, by using the support member 30 made of the fiber reinforced resin, it is possible to reduce a weight of the support member 30 while maintaining a strength of the support member 30.

(1-5) The front end surface 24 of the coupling portion 23 has the accommodating recessed portion 26 configured to accommodate the extension portion 35.

According to the configuration, in the case where the extension portion 35 made of the resin is located between the coupling portion 23, which is the front end of the crash box 20, and the bumper reinforcement 50, the extension portion 35 is accommodated in the accommodating recessed portion 26. Accordingly, a compressive stress acting on the extension portion 35 sandwiched between the crash box 20 and the bumper reinforcement 50 can be reduced. Therefore, creep deformation of the extension portion 35 is prevented. Therefore, the durability of the support member 30 can be improved.

### Second Embodiment

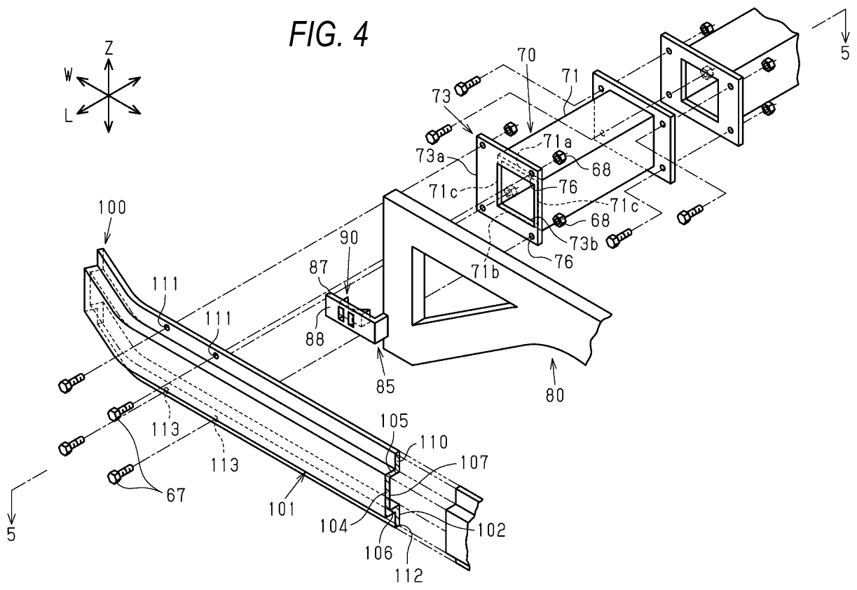

Next, the second embodiment of the front structure of a vehicle will be described with reference to FIGS. 4 to 6, focusing on differences from the first embodiment.

In the following description, configurations in the second embodiment that are the same as or correspond to those in the first embodiment are denoted by reference numerals obtained by adding “50” to reference numerals “**” of the configurations in the first embodiment, and redundant description may be omitted.

### <Crash Box 70>

As illustrated in FIG. 4, a coupling portion 73 having a rectangular annular shape in a front view is coupled to a front end of a tubular portion 71. The coupling portion 73 has a protruding portion 73a protruding outward in a radial direction of the tubular portion 71 and a cutout portion 73b not protruding outward in the radial direction of the tubular portion 71.

In the present embodiment, the front end of the tubular portion 71 has a square shape in a front view. The front end of the tubular portion 71 extends in the vehicle width direction W, and has an upper edge 71a and a lower edge 71b formed at an interval in the upper-lower direction Z, and a pair of side edges 71c that connects end portions of the upper edge 71a and respective end portions of the lower edge 71b in the vehicle width direction W.

The protruding portion 73a is coupled to the upper edge 71a, the lower edge 71b, and

the side edge 71c on an outer side in the vehicle width direction W of the pair of side edges 71c of the front end of the tubular portion 71.

The cutout portion 73b is coupled to the side edge 71c on an inner side in the vehicle width direction W of the pair of side edges 71c.

A through hole 76, which penetrates the coupling portion 73 in the front-rear direction L, is formed at each of four corner portions of the protruding portion 73a.

### <Support Member 80>

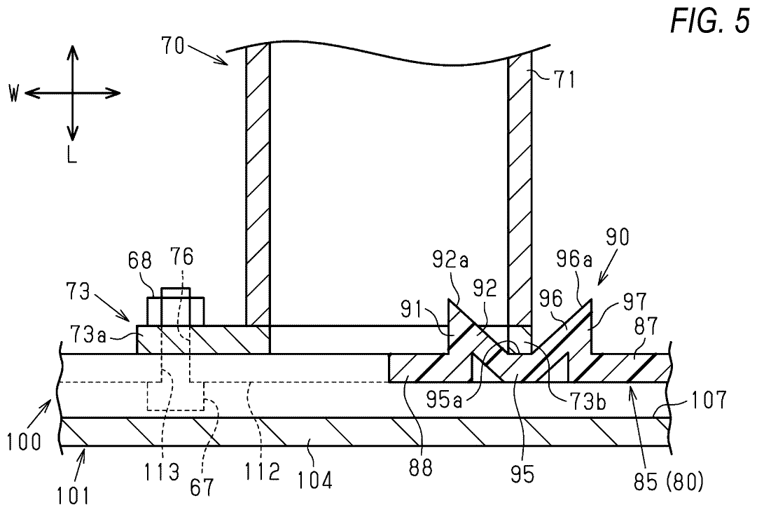

As illustrated in FIGS. 4 and 5, a second portion 87 of an extension portion 85 includes a plate-shaped base portion 88 and a guide portion 90 protruding rearward from the base portion 88.

As illustrated in FIG. 5, the guide portion 90 includes a first wall portion 91, a second wall portion 92, an intermediate wall portion 95, a third wall portion 96, and a fourth wall portion 97.

The first wall portion 91 and the fourth wall portion 97 are formed at an interval in the vehicle width direction W, and protrude rearward from the base portion 88 along the front-rear direction L.

The second wall portion 92 extends inward in the vehicle width direction W and forward from a rear end of the first wall portion 91. The second wall portion 92 is inclined such that the more inward a portion is located in the vehicle width direction W, the more forward the portion is located.

A rear surface of the second wall portion 92 is an inclined surface 92a which is inclined with respect to both the front-rear direction L and the vehicle width direction W, and is in contact with the cutout portion 73b from an inner peripheral side of the tubular portion 71.

The third wall portion 96 extends outward in the vehicle width direction W and forward from a rear end of the fourth wall portion 97. The third wall portion 96 is inclined such that the more outward a portion is located in the vehicle width direction W, the more forward the portion is located. A rear surface of the third wall portion 96 is an inclined surface 96a which is inclined with respect to both the front-rear direction L and the vehicle width direction W, and is in contact with the cutout portion 73b from an outer peripheral side of the tubular portion 71.

That is, the guide portion 90 sandwiches the cutout portion 73b from the inner peripheral side and the outer peripheral side of the tubular portion 71 by the inclined surface 92a and the inclined surface 96a.

The intermediate wall portion 95 couples a front end of the second wall portion 92 and a front end of the third wall portion 96 and extends in the vehicle width direction W. The intermediate wall portion 95 has a facing surface 95a facing a front end of the cutout portion 73b.

### <Bumper Reinforcement 100>

As illustrated in FIG. 4, the bumper reinforcement 100 includes a plate-shaped main body portion 101 extending in the vehicle width direction W, and an upper attachment portion 110 and a lower attachment portion 112 that are coupled to the main body portion 101. The main body portion 101 includes a front wall portion 104 extending in the upper-lower direction Z, an upper wall portion 105 extending rearward from an upper end of the front wall portion 104, and a lower wall portion 106 extending rearward from a lower end of the front wall portion 104. An accommodating recessed portion 107 having a U-shaped cross section is formed on a rear surface 102 of the main body portion 101 by the front wall portion 104, the upper wall portion 105, and the lower wall portion 106.

As illustrated in FIG. 5, the second portions 87 of the extension portions 85 are accommodated inside the accommodating recessed portion 107. In the present embodiment, the front wall portion 104 and the second portion 87 are separated from each other in the front-rear direction L.

As illustrated in FIG. 4, the upper attachment portion 110 extends upward from a rear end of the upper wall portion 105.

The lower attachment portion 112 extends downward from a rear end of the lower wall portion 106.

On the upper attachment portion 110 and the lower attachment portion 112, through holes 111 and through holes 113 are respectively formed at positions corresponding to the through holes 76 of the coupling portion 73.

The bumper reinforcement 100 is attached to front ends of the pair of crash boxes 70 by screwing nuts 68 to respective bolts 67 inserted through the through holes 76 and 111 and bolts 67 inserted through the through holes 76 and 113.

### Functions and Effects of Second Embodiment

According to the present embodiment, the following functions and effects can be implemented in addition to the functions and effects (1-1), (1-3), and (1-4) of the first embodiment.

(2-1) The guide portion 90 has the pair of inclined surfaces 92a and 96a configured to sandwich the cutout portion 73b from the inner peripheral side and the outer peripheral side of the tubular portion 71 in the vehicle width direction W, and the facing surface 95a facing the front end of the cutout portion 73b.

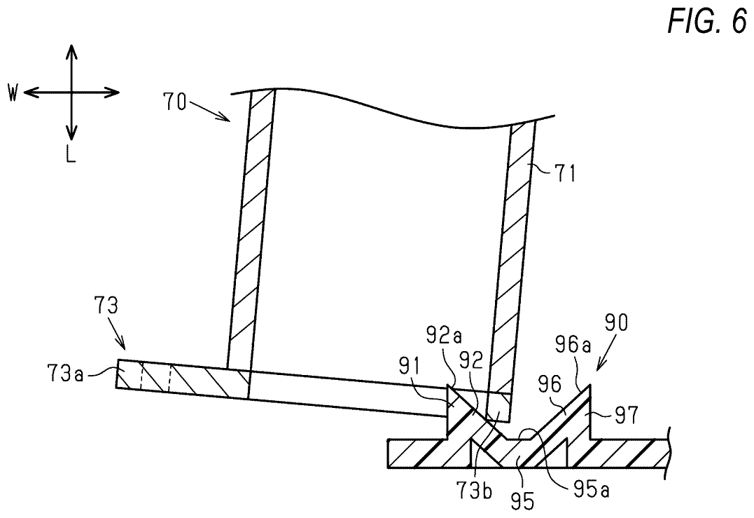

According to such a configuration, as illustrated in FIG. 6, the guide portion 90 is engaged with the cutout portion 73b of the coupling portion 73, so that the crash box 70 is guided to an attachment position along the inclined surface 92a in the vehicle width direction W. Further, as illustrated in FIG. 5, the cutout portion 73b is surrounded by the pair of inclined surfaces 92a and 96a and the facing surface 95a, so that a relative movement of the crash box 70 with respect to the support member 80 is restricted. Therefore, the crash box 70 can be fixed at the attachment position.

(2-2) The rear surface 102 of the bumper reinforcement 100 has the accommodating recessed portion 107 configured to accommodate the extension portions 85.

According to such a configuration, in the case where the extension portion 85 made of the resin is located between the coupling portion 73, which is the front end of the crash box 70, and the bumper reinforcement 100, the extension portions 85 are accommodated in the accommodating recessed portion 107. Accordingly, a compressive stress acting on the extension portion 85 sandwiched between the crash box 70 and the bumper reinforcement 100 can be reduced. Therefore, creep deformation of the extension portion 85 is prevented. Therefore, the durability of the support member 80 can be improved.

### <Modifications>

The present embodiment can be modified and implemented as follows. The present embodiment and the following modifications can be combined with each other and implemented without technical contradiction.

In the above-described first embodiment, the front surface of the base portion 38 of the extension portion 35 is located on the same plane as the flat portion 25 of the front end surface 24 of the coupling portion 23, but the front surface of the base portion 38 may be located behind the flat portion 25.

In the above-described first embodiment, the accommodating recessed portion 26 is formed on the front end surface 24 of the coupling portion 23, and in the above-described second embodiment, the accommodating recessed portion 107 is formed on the rear surface 102 of the bumper reinforcement 100, but the present invention is not limited to the this. The accommodating recessed portions 26, 107 may be omitted as long as the creep deformation of the extension portions 35, 85 caused by being respectively sandwiched between the front ends of the crash boxes 20, 70 and the bumper reinforcements 50, 100 is small.

The support members 30, 80 may be made of the metal.

In the above-described embodiments, the support members 30, 80 are each integrally molded, but a support body and an extension portion, which are separately formed, may be attached to each other.

In the above-described first embodiment, the two holes 27 into which the first guide portion 40 and the second guide portion 45 are respectively inserted are used as the engaged portions, but the engaged portions may be two apertures into which the first guide portion 40 and the second guide portion 45 are respectively inserted.

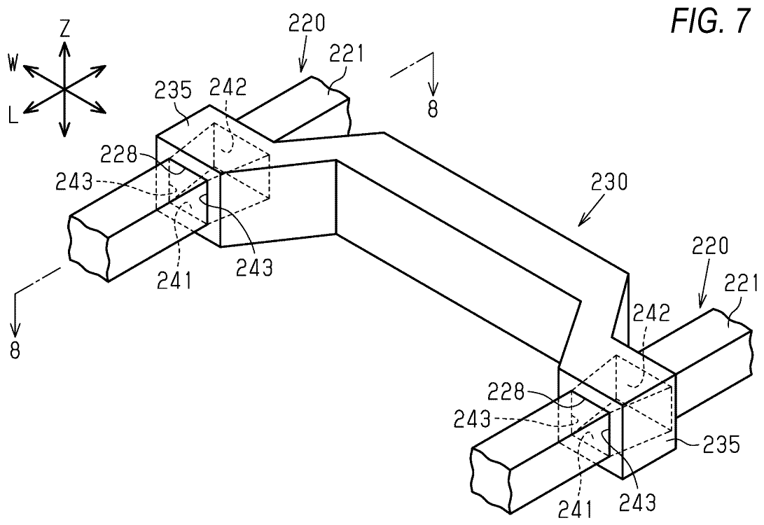

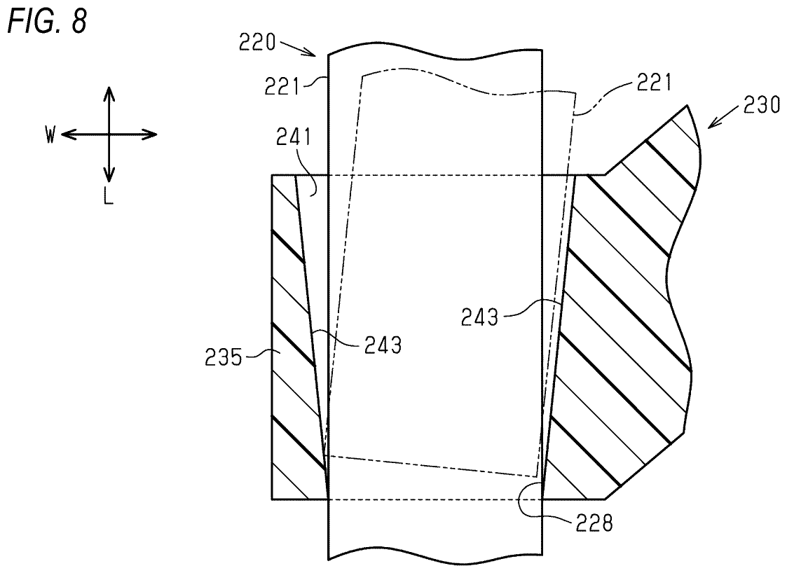

In the above-described first embodiment, the first guide portion 40 and the second guide portion 45 are inserted into the respective holes 27, and in the above-described second embodiment, the cutout portion 73b is sandwiched by the inclined surfaces 92a and 96a of the guide portion 90, but the present invention is not limited to this. As illustrated in FIGS. 7 and 8, a pair of extension portions 235 of a support member 230 may respectively have a through hole 228 which extends in the front-rear direction L and through which a tubular portion 221 of a crash box 220 is inserted. As illustrated in FIG. 7, the through hole 228 has a rectangular cross section, and has a bottom surface 241 extending along both the front-rear direction L and the vehicle width direction W, a top surface 242 facing the bottom surface 241 in the upper-lower direction Z, and a pair of side surfaces 243 that are located on both sides in the vehicle width direction W and couple the bottom surface 241 and the top surface 242. The bottom surface 241 and the top surface 242 are parallel to each other and sandwich the tubular portion 221 in the upper-lower direction Z. As illustrated in FIG. 8, the pair of side surfaces 243 are inclined such that a distance between the pair of side surfaces 243 in the vehicle width direction W increases as the pair of side surfaces 243 extend rearward (upper side in FIG. 8). The crash box 220 is guided to an attachment position indicated by a solid line in FIG. 8 by engaging a tip of the crash box 220 indicated by a two-dot chain line in FIG. 8 with inclined surfaces of the side surfaces 243. Even in this case, the same effect as the above-described effect (1-1) can be implemented.

In the above-described embodiments, the inclined surfaces 42a, 46a, 47a, 92a, and 96a are inclined with respect to both the front-rear direction L and the vehicle width direction W, but the present invention is not limited to this. For example, a guide portion may have an inclined surface which is inclined with respect to both the front-rear direction L and the upper-lower direction Z. In this case, a crash box is guided to an attachment position along the inclined surface of the guide portion in the upper-lower direction Z.

In the above-described embodiments, a pair of vehicle body frames to which the crash boxes 20 or the crash boxes 70 are attached are embodied as front side members, but the pair of vehicle body frames may be, for example, suspension members.

What is claimed is:

1. A front structure of a vehicle, comprising:
a pair of vehicle body frames disposed at an interval in a vehicle width direction;
a pair of crash boxes located in front of the vehicle body frames in a front-rear direction of the vehicle, and attached to the vehicle body frames respectively;
a support member including a support body located between the pair of crash boxes, and a pair of extension portions that extend outward in the vehicle width direction from the support body and are located on both sides of the support body in the vehicle width direction; and
a bumper reinforcement that extends in the vehicle width direction, and is attached to front ends of the pair of crash boxes,
wherein the extension portion includes a guide portion configured to guide the crash box to an attachment position by engaging with a front end of the crash box, the guide portion having an inclined surface that is inclined with respect to the front-rear direction.

2. The front structure of a vehicle according to claim 1,
wherein the crash box includes a tubular portion extending in the front-rear direction, and a coupling portion coupled to a front end of the tubular portion and protruding to an outer peripheral side of the tubular portion,
a front end surface of the coupling portion has two engaged portions having a hole shape or an aperture shape and provided at an interval in the vehicle width direction, and
two of the guide portions are inserted into the two engaged portions respectively.

3. The front structure of a vehicle according to claim 1,
wherein the crash box includes a tubular portion extending in the front-rear direction, and a coupling portion coupled to a front end of the tubular portion,
the coupling portion has a cutout portion not protruding outward in a radial direction of the tubular portion, and
the guide portion has a pair of the inclined surfaces configured to sandwich the cutout portion from an inner peripheral side and an outer peripheral side of the tubular portion in the vehicle width direction, and a facing surface facing a front end of the cutout portion.

4. The front structure of a vehicle according to claim 1,
wherein the support member including the support body and the pair of extension portions is integrally molded.

5. The front structure of a vehicle according to claim 4,
wherein the support member is made of a fiber reinforced resin.

6. The front structure of a vehicle according to claim 5,
wherein the crash box includes a tubular portion extending in the front-rear direction, and a coupling portion coupled to a front end of the tubular portion and protruding to an outer peripheral side of the tubular portion, and
a front end surface of the coupling portion has an accommodating recessed portion configured to accommodate the extension portion.

7. The front structure of a vehicle according to claim 5,
wherein a rear surface of the bumper reinforcement has an accommodating recessed portion configured to accommodate the extension portion.
